(19) United States
(12) Patent Application Publication
(10) Pub. No.: US 2009/0061864 A1
(43) Pub. Date: Mar. 5, 2009

(54) MOBILE COMMUNICATION SYSTEM AND CELL SEARCHING METHOD THEREOF

(75) Inventor: Chang Ho SOHN, Seongnam-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/199,259

(22) Filed: Aug. 27, 2008

(30) Foreign Application Priority Data
Aug. 29, 2007 (KR) 2007-87142

(51) Int. Cl. H04W 4/00

(52) U.S. Cl. 455/434; 455/450

(57) ABSTRACT

A mobile communication system and cell searching method of the mobile communication network is provided for simplifying a synchronization process required for selecting a target cell. The cell searching method for a mobile communication system includes transmitting, at a base station, a first synchronization signal of a first slot of a frame of a first channel at a higher transmission power than a transmission power of a remainder of the frame of the first channel, acquiring, at a mobile station, a slot synchronization using the first synchronization signal, and acquiring, at the mobile station, a frame synchronization using a second synchronization signal of a second channel, wherein the second synchronization signal corresponds to the first synchronization signal.

### PRIORITY

This application claims the benefit under 35 U.S.C. §119(a) of a Korean patent application filed in the Korean Intellectual Property Office on Aug. 29, 2007 and assigned Serial No. 2007-0087142, the entire disclosure of which is hereby incorporated by reference.

### BACKGROUND OF THE INVENTION

1. Field of the Invention

The present invention relates to a mobile communication system. More particularly, the present invention relates to a mobile communication system and cell searching method of the mobile communication system that is capable of simplifying a synchronization process required for selecting a target cell.

2. Description of the Related Art

Conventionally, base stations in a mobile communication system are identified by unique cell specific codes. For example, in a mobile communication system including 512 base stations, the base stations are each identified by a respective one of 512 cell specific codes.

In order to simplify a code calculation process, the base stations are grouped into several code groups. For example, the 512 base stations can be grouped into 32 code groups with each group using a respective one of the 32 group identification codes.

A hierarchical cell selection algorithm is used to search for a cell in a stepwise manner. In such a hierarchical cell selection algorithm, a mobile station first acquires slot time synchronization using a Primary Synchronization Code (PSC) carried by a Primary Synchronization CHannel (P-SCH).

After acquiring slot time synchronization, the mobile station acquires frame synchronization and a code group with reference to a Second Synchronization Code (SSC) carried by a Secondary Synchronization CHannel (S-SCH).

Next, the mobile station determines a primary scrambling code used by the base station through a symbol-to-symbol correlation with the Common PIlot CHannel (CPICH) using all codes within the code group. After the primary scrambling code has been identified, a Primary Common Control Physical CHannel (P-CCPH) can be detected and the system and cell specific Broadcasting CHannel (BCH) information can be read, thereby enabling selection of a target base station.

FIG. 1 is a diagram illustrating frame timing and slot timing of downlink physical channels in a conventional mobile communication system.

As shown in FIG. 1, the P-SCH, S-SCH, and CPICH have identical frame timings. While the following example is described with the CPICH, the CPICH can be replaced by a Common Control Physical CHannel (CCPCH). Here, the common channel is the CPICH carrying a Common Packet CHannel (CPCH).

In FIG. 1, reference numerals 1, 2, and 3 denote the P-SCH, S-SCH, and CPICH, respectively. A frame is composed of 15 slots, and each slot has a duration corresponding to 2560 chips at the system chip rate.

The P-SCH and S-SCH are transmitted with equal power. In the conventional cell searching method of a mobile communication system, cell searching is performed in an order of slot timing synchronization of the PSC on the P-SCH, frame synchronization is performed using the SSC on the S-SCH, and the comparing of the codes with the scrambling codes is performed on the CPICH. However, in the conventional cell searching method, the mobile station may have to search through 64 code groups and 15 slots in order to find the primary scrambling code, which may result in a system overload. Accordingly, there is a need for a simplified scrambling code searching process.

### SUMMARY OF THE INVENTION

An aspect of the present invention is to address at least the above-mentioned problems and/or disadvantages and to provide at least the advantages described below. Accordingly, an aspect of the present invention is to provide a fast cell searching method.

In accordance with an aspect of the present invention, a cell searching method for a mobile communication system is provided. The method includes transmitting, at a base station, a first synchronization signal of a first slot of a frame of a first channel at a higher transmission power than a transmission power of a remainder of the frame of the first channel, acquiring, at a mobile station, a slot synchronization using the first synchronization signal, and acquiring frame synchronization using a second synchronization signal of a second channel, wherein the second synchronization signal corresponds to the first synchronization signal.

According to another aspect of the present invention, the second synchronization signal is orthogonal to the first synchronization signal.

According to yet another aspect of the present invention, the second synchronization signal of a first slot of a frame of the second channel is transmitted by the base station at a lower transmission power than a transmission power of a remainder of the frame of the second channel.

According to still another aspect of the present invention, the difference between the transmission power of the first synchronization signal of the first slot of the frame of the first channel and the transmission power of the remainder of the frame of the first channel is substantially equal to the difference between the transmission power of the second synchronization signal of the first slot of the frame of the second channel and the transmission power of the remainder of the frame of the second channel.

According to a further aspect of the present invention, the cell searching method further includes selecting a cell using the frame synchronization acquired by the mobile station.

According to still a further aspect of the present invention, the cell searching method further includes selecting a cell using the frame synchronization acquired by the mobile station, wherein the frame comprises 15 slots and is 2560 chips in length.

According to another aspect of the present invention, the first synchronization signal comprises a Primary Synchronization Code (PSC).

According to yet another aspect of the present invention, the first channel comprises a Primary Synchronization CHannel (P-SCH).

According to still another aspect of the present invention, the second first synchronization signal comprises a Secondary Synchronization Code (SSC).

According to a further aspect of the present invention, the second channel comprises a Secondary Synchronization CHannel (P-SCH).

In accordance with another aspect of the preset invention, a mobile communication system is provided. The system includes a base station for transmitting a first synchronization of a first slot of a frame of a first channel at a higher transmission power than a transmission power of a remainder of the frame of the first channel, and a mobile station for acquiring slot synchronization using the first synchronization signal and for acquiring frame synchronization using a second synchronization signal of a second channel, wherein the second synchronization signal corresponds to the first synchronization signal.

According to another aspect of the present invention, the second synchronization signal is orthogonal to the first synchronization signal.

According to yet another aspect of the present invention, the base station transmits the second synchronization signal of a first slot of a frame of the second channel at lower transmission power than a transmission power of a remainder of the frame of the second channel.

According to still another aspect of the present invention, the difference between the transmission power of the first synchronization signal of the first slot of the frame of the first channel and the transmission power of the remainder of the frame of the first channel is substantially equal to the difference between the transmission power of the second synchronization signal of the first slot of the frame of the second channel and the transmission power of the remainder of the frame of the second channel.

According to a further aspect of the present invention, the mobile station selects a cell using the frame synchronization.

According to still a further aspect of the present invention, the frame comprises 15 slots and is 2560 chips in length, and the mobile station selects a cell using the frame synchronization.

According to another aspect of the present invention, the first synchronization signal comprises a Primary Synchronization Code (PSC).

According to yet another aspect of the present invention, the first channel comprises a Primary Synchronization CHannel (P-SCH).

According to still another aspect of the present invention, the second first synchronization signal comprises a Secondary Synchronization Code (SSC).

According to a further aspect of the present invention, the second channel comprises a Secondary Synchronization CHannel (P-SCH).

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a diagram illustrating frame timing and slot timing of downlink physical channels in a conventional mobile communication system;

FIG. 2 is a diagram illustrating a frame structure for use in a mobile communication system according to an exemplary embodiment of the present invention;

FIG. 3 is a diagram illustrating a structure of a frame transmitted by a base station of a mobile communication system according to an exemplary embodiment of the present invention;

FIG. 4 is a diagram illustrating frame timing and slot timing of down link physical channels in a mobile communication system according to an exemplary embodiment of the present invention; and

FIG. 5 is a flowchart illustrating a cell searching method for a mobile communication system according to an exemplary embodiment of the present invention.

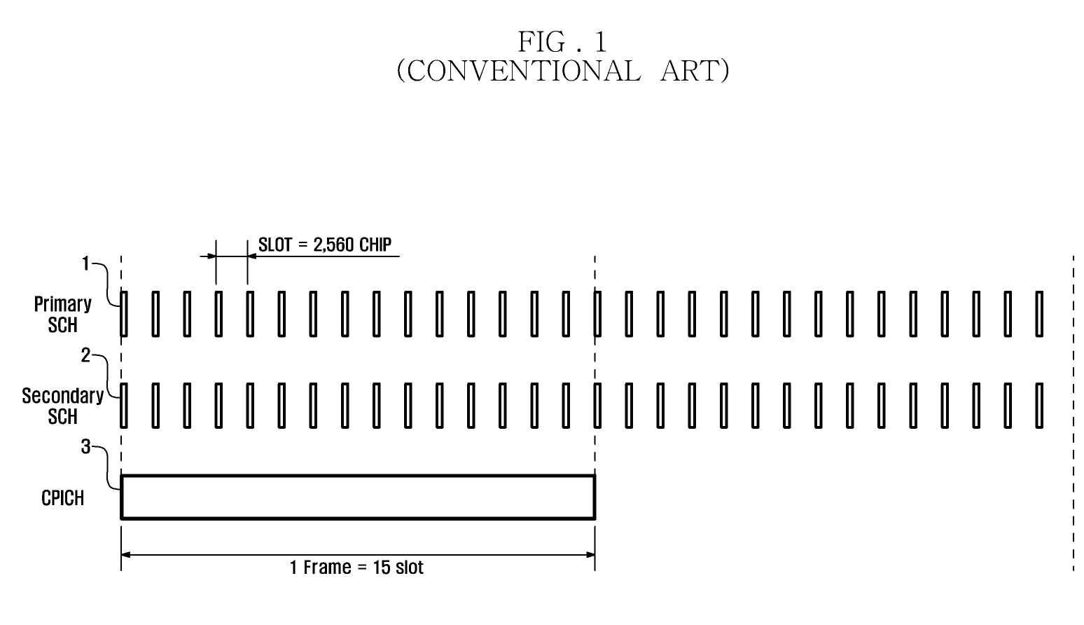

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The following description omits a detailed description on the primary scrambling code searching procedure performed through a symbol-to-symbol correlation over the Common Pilot Channel (CPICH) with all codes within the code group.

In the following description, the mobile station can be any of a mobile phone, a digital broadcast receiver, a Personal Digital Assistant (PDA), a Smartphone, a Code Division Multiple Access (CDMA) terminal, a Wideband CDMA (WCDMA) terminal, and equivalent devices having a wireless communication function.

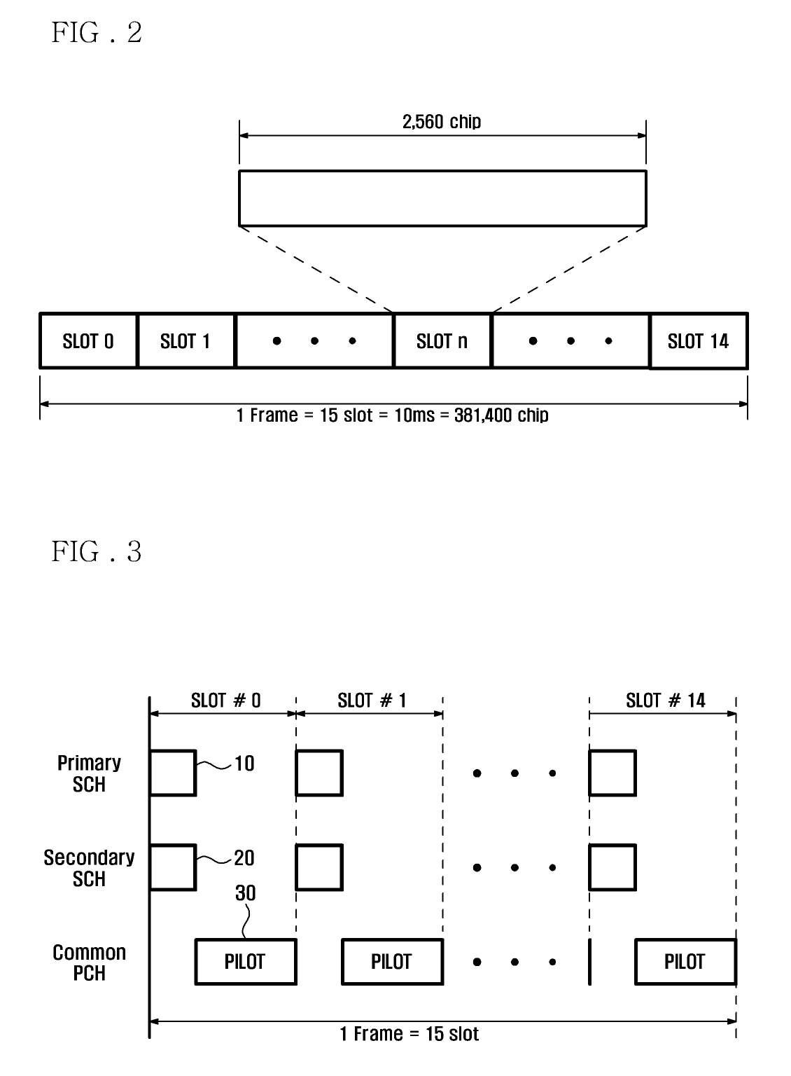

FIG. 2 is a diagram illustrating a frame structure for use in a mobile communication system according to an exemplary embodiment of the present invention.

Referring to FIG. 2, a frame is 10 ms in length, which is equal in duration to 38400 chips. The frame is divided into 15 slots, each having a length of 2560 chips. The content of the respective 15 slots differs from each other according to a type of channel implemented.

A Synchronization CHannel (SCH) is transmitted by a base station so that a mobile station may use the SCH for cell searching. In order for the mobile station to recover BCH information transmitted by the base station, the mobile station has to acquire synchronization with the base station. The SCH is used for acquiring the synchronization.

The base station is assigned a cell specific code to be distinguished from other base stations. For example, if a mobile communication system is composed of 512 cells, 512 cell specific codes are assigned to the respective calls.

In order to facilitate the cell searching process, the base stations are partitioned into code groups, e.g. 64 groups that each comprises 8 scrambling codes. The base stations transmit 8 scrambling codes through the SCH. The SCH is described in more detail with reference to FIG. 3.

FIG. 3 is a diagram illustrating a structure of a frame transmitted by a base station of a mobile communication system according to an exemplary embodiment of the present invention.

As described above, the SCH and CPICH have identical frame timings. The SCH carries two subchannels, the Primary SCH (P-SCH) and Secondary SCH (S-SCH). While the CPICH is described herein, the CPICH can be substituted with a CCPCH carrying the BCH.

In FIG. 3, reference numerals 10, 20, and 30 denote the Primary Synchronization Code (PSC) of the first slot of the P-SCH, the Secondary Synchronization Code (SSC) of the first slot of the S-SCH, and CPICH, respectively. A frame of 10 ms is split into 15 slots, and each slot is 2560 chips long.

The PSC 10 and the SSC 20 are transmitted during the first 256 chips of each time slot over the P-SCH and the S-SCH and they are orthogonal to each other.

Accordingly, when the mobile station acquires the PSC 10 transmitted on the P-SCH, the SSC 20 can be acquired. In addition, if the SSC 20 is acquired first, the mobile station can acquire the PSC 10, which is orthogonal to the SSC 20.

The cell searching method according to this exemplary embodiment uses the above-identified characteristics. Unlike the conventional stepwise cell searching method, which detects start times of slots and finds a start time of the frame among them, the cell searching method according to an exemplary embodiment of the present invention enables direct detection of the start time of a frame using the PSC 10. For this purpose, the PSC 10 of the first slot has a start time that is identical with the start time of the frame and is transmitted at a higher transmission power than the remaining portion of the frame, which is transmitted at a normal transmission power level.

The control of the transmission power of the synchronization codes is described in more detail below.

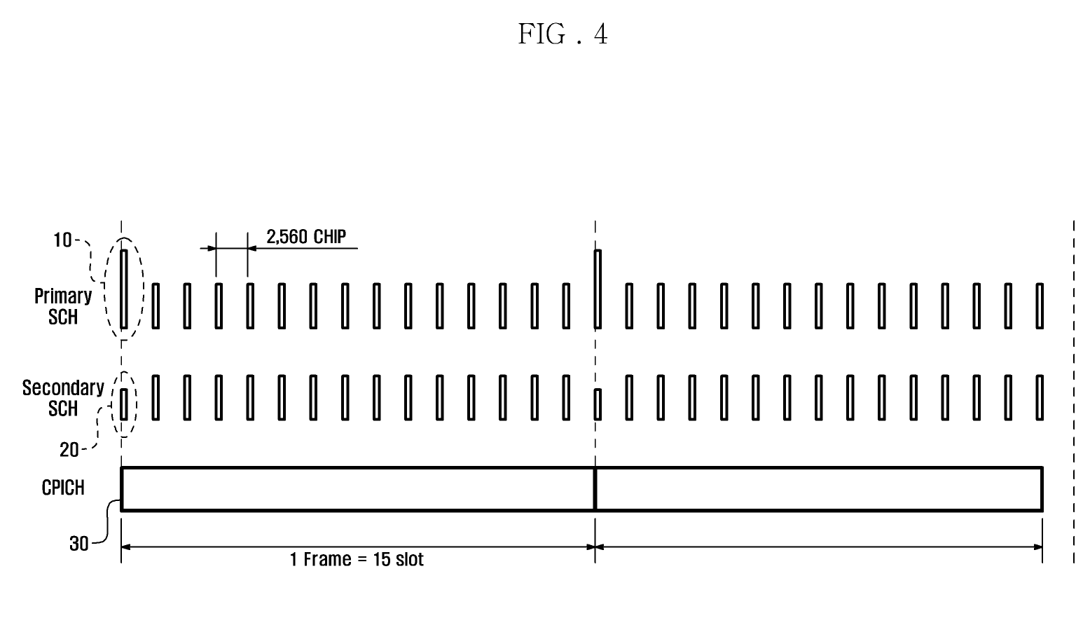

FIG. 4 is a diagram illustrating frame timing and slot timing of down link physical channels in a mobile communication system according to an exemplary embodiment of the present invention.

Referring to FIG. 4, the P-SCH, S-SCH, and CPICH have identical frame timings. Reference numerals 10, 20, and 30 denote the PSC of the first slot on the P-SCH, SSC of the first slot on the S-SCH, and CPICH, respectively.

In FIG. 4, two consecutive frames are illustrated. Each frame consists of 25 slots, and each slot is 2560 chips in length.

In this exemplary embodiment, the base station transmits the PSC of the first slot of each frame at a higher transmission power than the remainder of the frame, which is transmitted at a normal transmission power level. In this case, the SSC 20, which is orthogonal to the PSC 10 of the first slot of the frame, is transmitted at a lower transmission power than the remainder of the frame, which is transmitted at a normal transmission power level. This occurs because the increased transmission power of only the PSC 10 requires increasing the transmission power of the CPICH 30, thereby resulting in a waste of power.

Accordingly, the mobile station can acquire the slot synchronization using the PSC 10, which is transmitted at an increased power, and can find the frame synchronization using the SSC 20, which is orthogonal to the PSC 10.

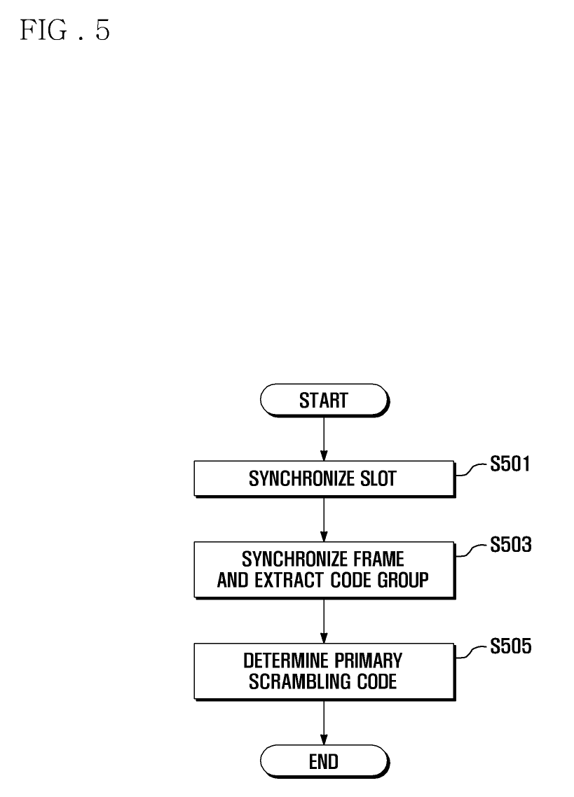

FIG. 5 is a flowchart illustrating a cell searching method for a mobile communication system according to an exemplary embodiment of the present invention.

Referring to FIG. 5, a mobile station receives the P-SCH transmitted by the base station and acquires slot timing using the PSC 10 carried by the P-SCH in step S501.

The P-SCH carries a 256-chip codeword generated by a 16-bit chip sequence. The base station transmits the same codeword on the P-SCH.

That is, the base station transmits the PSC 10 in every slot in order to establish a slot boundary, i.e. 15 times per frame. Using the PSC, the mobile station can acquire the start times of the slots.

In this exemplary embodiment, the mobile station can find the start time of the frame simultaneously. Since the base station transmits the PSC of the first slot of the frame with a higher transmission power than the remainder of the frame, which is transmitted at a normal transmission power level. Thereby, the mobile terminal can find the start time of the frame based on the transmission power of the PSC on the P-SCH.

After acquiring the slot synchronization, the mobile station acquires the frame synchronization using the SSC 20 and extracts a code group to which the base station belongs in step S503.

The PSC and SSC are orthogonal to each other, and the base station transmits the PSC of the first slot of each frame at a higher transmission power than the remainder of the frame, which is transmitted at a normal transmission power level. Accordingly, the mobile station can acquire the frame synchronization using the SSC 20, which is orthogonal to the PSC 10 that is received at the higher transmission power.

Next, the mobile station determines a primary scrambling code used by the base station through a symbol-to-symbol correlation with the CPICH using all of the scrambling codes within the code group in step S505.

Since the start time of the frame is detected right after the acquisition of the start time of the first slot, the frame synchronization can be acquired 15 times faster than the conventional stepwise cell searching method. That is, the cell searching method according to this exemplary embodiment can more quickly acquire frame synchronization by performing only one correlation calculation on a single slot rather than all 15 slots of the frame.

Consequently, the mobile station receives the BCH information transmitted by the base station, which is identified by the primary scrambling code, and selects the base station using the cell specific code extracted from the BCH information.

As shown in FIG. 4, the base station transmits the SSC 20 of the first slot of each frame at a lower transmission power than the remainder of the frame, which is transmitted at a normal transmission power level. Preferably, the transmission power of the SSC 20 of the first slot is lowered by as much as the transmission power for the PSC is increased relative to the transmission power of the remainder of the frame.

This is because the increased transmission power of the PSC 10 on the P-SCH requires increasing the transmission power of the CPICH 30, thereby resulting in a waste of power. Although the transmission power of the SSC 20 of the first slot is decreased, there is no loss in an ability to find the code group with the remaining 14 slots, which are transmitted a normal transmission power level.

While the present invention has been shown and described with reference to certain exemplary embodiments thereof, it will be understood by those skilled in the art that various changes in form and details may be made therein without departing from the spirit and scope of the present invention as defined in the appended claims and their equivalents.

Although the cell searching method is described in association with an asynchronous mobile communication network, the present invention is not limited thereto. For example, the cell searching method of exemplary embodiments of the present invention can be applied to various types of mobile communication systems for performing slot and frame synchronizations using two synchronization channels that are orthogonal to each other.

As described above, in the cell searching method for a mobile communication system according to exemplary embodiments of the present invention, a base station transmits a primary synchronization code of a primary synchronization channel of the first slot of a frame at a higher transmission power than the remainder of the frame, which is transmitted at a normal transmission power level, whereby a mobile station performs frame synchronization and slot synchronization.

What is claimed is:

1. A cell searching method for a mobile communication system, the method comprising:
transmitting, at a base station, a first synchronization signal of a first slot of a frame of a first channel at a higher transmission power than a transmission power of a remainder of the frame of the first channel;
acquiring, at a mobile station, a slot synchronization using the first synchronization signal; and
acquiring frame synchronization using a second synchronization signal of a second channel, wherein the second synchronization signal corresponds to the first synchronization signal.

2. The method of claim 1, wherein the second synchronization signal is orthogonal to the first synchronization signal.

3. The method of claim 2, wherein the second synchronization signal of a first slot of a frame of the second channel is transmitted by the base station at a lower transmission power than a transmission power of a remainder of the frame of the second channel.

4. The method of claim 3, wherein the difference between the transmission power of the first synchronization signal of the first slot of the frame of the first channel and the transmission power of the remainder of the frame of the first channel is substantially equal to the difference between the transmission power of the second synchronization signal of the first slot of the frame of the second channel and the transmission power of the remainder of the frame of the second channel.

5. The method of claim 1, further comprising selecting a cell using the frame synchronization acquired by the mobile station.

6. The method of claim 1, further comprising selecting a cell using the frame synchronization acquired by the mobile station, wherein the frame comprises 15 slots and is 2560 chips in length.

7. The method of claim 1, wherein the first synchronization signal comprises a Primary Synchronization Code (PSC).

8. The method of claim 1, wherein the first channel comprises a Primary Synchronization CHannel (P-SCH).

9. The method of claim 1, wherein the second first synchronization signal comprises a Secondary Synchronization Code (SSC).

10. The method of claim 1, wherein the second channel comprises a Secondary Synchronization CHannel (S-SCH).

11. A mobile communication system, the system comprising:
a base station for transmitting a first synchronization of a first slot of a frame of a first channel at a higher transmission power than a transmission power of a remainder of the frame of the first channel; and
a mobile station for acquiring slot synchronization using the first synchronization signal and for acquiring frame synchronization using a second synchronization signal of a second channel, wherein the second synchronization signal corresponds to the first synchronization signal.

12. The system of claim 6, wherein the second synchronization signal is orthogonal to the first synchronization signal.

13. The system of claim 7, wherein the base station transmits the second synchronization signal of a first slot of a frame of the second channel at lower transmission power than a transmission power of a remainder of the frame of the second channel.

14. The system of claim 13, wherein the difference between the transmission power of the first synchronization signal of the first slot of the frame of the first channel and the transmission power of the remainder of the frame of the first channel is substantially equal to the difference between the transmission power of the second synchronization signal of the first slot of the frame of the second channel and the transmission power of the remainder of the frame of the second channel.

15. The system of claim 6, wherein the mobile station selects a cell using the frame synchronization.

16. The system of claim 6, wherein the frame comprises 15 slots and is 2560 chips in length, and the mobile station selects a cell using the frame synchronization.

17. The system of claim 11, wherein the first synchronization signal comprises a Primary Synchronization Code (PSC).

18. The system of claim 11, wherein the first channel comprises a Primary Synchronization CHannel (P-SCH).

19. The system of claim 11, wherein the second first synchronization signal comprises a Secondary Synchronization Code (SSC).

20. The system of claim 11, wherein the second channel comprises a Secondary Synchronization CHannel (S-SCH).
